(19) United States
(12) Patent Application Publication
(10) Pub. No.: US 2025/0157008 A1
(43) Pub. Date: May 15, 2025

(54) Image Generation with Minimal Denoising Diffusion Steps

(71) Applicant: Google LLC, Mountain View, CA (US)

(72) Inventors: Tingbo Hou, Santa Clara, CA (US); Yanwu Xu, Boston, MA (US); Yang Zhao, Redmond, WA (US); Zhisheng Xiao, Bellevue, WA (US)

(21) Appl. No.: 18/949,522

(22) Filed: Nov. 15, 2024

Related U.S. Application Data
(60) Provisional application No. 63/599,490, filed on Nov. 15, 2023.

(51) Int. Cl. G06T 5/60; G06T 5/70

(52) U.S. Cl. CPC G06T 5/60; G06T 5/70; G06T 2207/20081; G06T 2207/20084

(57) ABSTRACT

Provided is a one-step text-to-image generative model, which represents a fusion of GAN and diffusion model elements. In particular, despite the promising outcomes of prior diffusion GAN hybrid models, achieving one-step sampling and extending their utility to text-to-image generation remains a complex challenge. The present disclosure provides a number of innovative techniques to enhance diffusion GAN models, resulting in an ultra-fast text-to-image model capable of producing high-quality images in a single sampling step.

### RELATED APPLICATIONS

This application claims priority to and the benefit of U.S. Provisional Patent Application No. 63/599,490, filed Nov. 15, 2023. U.S. Provisional Patent Application No. 63/599,490 is hereby incorporated by reference in its entirety.

### FIELD

The present disclosure relates generally to generative models in the field of artificial intelligence. More particularly, the present disclosure relates to a novel one-step text-to-image generative model, which represents a fusion of Generative Adversarial Network (GAN) and diffusion model elements.

### BACKGROUND

Diffusion models have emerged as an powerful class of generative models in recent years, delivering exceptional results in various generative modeling tasks, notably in synthesizing high-quality images conditioned on textual descriptions. These models have exhibited the potential to serve as crucial building blocks for a wide range of applications, including personalized generation, controlled generation, and image editing.

However, despite their impressive generative quality and broad utility, diffusion models have a significant limitation. They rely on performing a large number of diffusion steps via iterative denoising to generate final samples. This process results in slow generation speed and places substantial demands on computing resources, including processor cycles and memory. This slow inference and high computational demand present critical challenges to the real-time or on-device deployment of large-scale diffusion models, thus restricting their broader practical applicability.

Thus, a notable technical challenge in the field of diffusion models is reducing the number of required diffusion steps without compromising the quality of the generative results. This challenge is primarily due to the inherent trade-off between the step size and accuracy in solving the associated probability flow ordinary differential equation (PF-ODE). Despite efforts to advance numerical solvers tailored for the PF-ODE, the highly non-linear and complicated trajectory of the PF-ODE makes it extremely difficult to reduce the number of required sampling steps to a minimal level.

Alternative approaches, such as distilling the PF-ODE trajectory from a pre-trained diffusion model, have shown promise in reducing the number of sampling steps. However, these methods still face difficulties when it comes to extremely small step regimes, especially for large-scale text-to-image diffusion models. Therefore, there is an ongoing need to address this technical challenge by developing new formulations and techniques within the field of diffusion models.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method to train machine learning models. The method includes obtaining, by a computing system comprising one more computing devices, a pre-trained denoising diffusion model comprising a set of pre-trained model parameters. The method includes instantiating, by the computing system, a first instance of the pre-trained denoising diffusion model as a generator model having the set of pre-trained model parameters. The method includes instantiating, by the computing system, a second instance of the pre-trained denoising diffusion model as a discriminator model having the set of pre-trained model parameters. The method includes finetuning, by the computing system, at least the generator model on a finetuning dataset, wherein finetuning, by the computing system, the generator model comprises modifying, by the computing system, the set of pre-trained model parameters of the generator model based on a generative adversarial network loss term that provides a loss value based on an output of the discriminator model.

Other embodiments of this aspect include corresponding computer systems, apparatus, and computer programs recorded on one or more computer storage devices, each configured to perform the actions of the methods.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example training framework according to example embodiments of the present disclosure.

FIG. 2 depicts a graphical diagram of an example training framework according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

### Overview

The field of text-to-image (T2I) generation has achieved significant progress in creating high-quality images and videos. Nevertheless, a prevalent limitation stems from its reliance on the substantial number of iterative denoising diffusion steps. To address this challenge, the present disclosure provides a cutting-edge T2I generation model designed for instantaneous one-step image generation. The model's architecture scales with existing model designs and, in some implementations, can use a pretrained diffusion denoiser, demonstrating the potential of robust denoisers in initializing the discriminator's classifier.

More particularly, example aspects of the present disclosure are directed to a novel one-step text-to-image generative model, which represents a fusion of GAN and diffusion model elements. In particular, despite the promising outcomes of prior diffusion GAN hybrid models, achieving one-step sampling and extending their utility to text-to-image generation remains a complex challenge. The present disclosure provides a number of innovative techniques to enhance diffusion GAN models, resulting in an ultra-fast text-to-image model capable of producing high-quality images in a single sampling step. Given this achievement, some example implementations of the proposed model can be referred to as UFOGEN, an acronym denoting “You Forward Once” Generative Model. The UFOGEN model excels at generating high-quality images in just one inference step. Notably, when initialized with a pre-trained latent diffusion model (e.g. Stable Diffusion), this method efficiently transforms the latent diffusion model into a one-step inference model while preserving the quality of generated content. The UFOGEN model is among the first to achieve a reduction in the number of required sampling steps for text-to-image diffusion models to just one.

Thus, one example aspect of the present disclosure is directed to efficient techniques for training machine learning models, specifically focusing on the domain of T2I generation. In some implementations, a first step in the disclosed training framework involves obtaining a pre-trained denoising diffusion model. For example, this model can be any existing denoising diffusion model that has been trained on a large-scale dataset. The model can have a structured architecture that can be easily replicated, such as the Stable Diffusion model, which has demonstrated remarkable results in many generative modeling tasks.

Next, the computing system executing the training framework can instantiate two instances of the pre-trained denoising diffusion model. The first instance is used as a generator model, and the second instance is used as a discriminator model. Both models can be instantiated from the same set of pre-trained model parameters from the pre-trained denoising diffusion model. This design allows the generator and discriminator models to be initialized with rich internal features that contain information about the intricate interplay between textual and visual data.

The training system can then finetune the generator model on a finetuning dataset. The finetuning process can include modifying the pre-trained model parameters of the generator model based on a GAN loss term. This loss term can provide a loss value based on the output of the discriminator model, which effectively guides the generator model to produce more realistic images.

In addition to the GAN loss term, the generator model can also be finetuned based on a reconstruction loss term. This loss term can provide a loss value based on the output of the generator model itself. This additional loss term can help to match the distribution at the clean sample, reducing the variance introduced in the additive Gaussian noise when sampling with the generator model.

Some implementations of the proposed training framework can include finetuning the generator model on a text-to-image generation task. This capability allows the model to generate high-quality images conditioned on textual descriptions in a single inference step. This is a significant advancement in the field of T2I generation, as most existing models require multiple iterative denoising steps to produce comparable results.

The proposed training framework can additionally or alternatively be applied for the finetuning of the generator model on domain-specific downstream tasks. This versatility extends the potential applications of the model, making it suitable for a wide range of generative scenarios. This could include tasks such as personalized generation, controlled generation, and image editing.

A beneficial feature of the generator model in the disclosed framework is its ability to process a noise sample and generate a denoised synthetic image in a single denoising step. This feature is enabled by the innovative modifications made to the training objective, which allow the model to perform one-step sampling while retaining the ability to train with several denoising steps.

Other aspects of the present disclosure are directed to novel loss structures and functions for training the generator model in a combined diffusion-GAN training arrangement. In particular, in some implementations, the training process of the generator model involves a series of forward diffusion steps on a training example to generate a partially noised training example. An additional forward diffusion step is then performed to generate an additionally noised training example. The generator model then processes this example to generate a fully de-noised prediction. This prediction is then re-noised, and the discriminator model generates a prediction based on this re-noised example. The parameters of the generator model are then updated based on a loss function.

In particular, the loss function used in the training process of the generator model can include a reconstruction loss term and a GAN loss term. The reconstruction loss term can generate a reconstruction loss value based on the training example and the fully de-noised prediction. The GAN loss term, on the other hand, can generate a GAN loss value based on the discriminator prediction. This combination of loss terms ensures that the model is trained to generate high-quality images while also maintaining a balance between the generator and discriminator.

In some implementations, the generator model also incorporates a unique parameterization of the generator. In particular, the generator predicts a fully de-noised example from an additionally noised training example. This parameterization enables the model to match the distribution at the clean sample, paving the way for one-step sampling. This unique feature sets the generator model apart from traditional diffusion models and contributes to its efficiency and speed.

Thus, the present disclosure provides a novel and efficient solution for text-to-image generation. The proposed models combine the strengths of diffusion models and GANs, providing a fast and effective solution for generating high-quality images from textual descriptions. With its unique features and capabilities, the proposed model and training framework set a new benchmark in the field of T2I generative models, demonstrating potential for a wide range of applications.

The systems and methods of the present disclosure provide a number of technical effects and benefits. In particular, example implementations of the present disclosure address the technical problem of slow and computationally demanding T2I generation associated with the use of multiple iterative denoising steps to generate high-quality images from textual descriptions. The use of large numbers of denoising steps results in slow inference speeds and high computational demands, making real-time or on-device deployment challenging.

The present invention offers a technical solution to this problem by providing a novel one-step text-to-image generative model. This model fuses elements of GAN and diffusion models, overcoming the limitations of traditional models that require multiple denoising steps.

In particular, some example implementations use a unique parameterization of the generator in the model. The generator is designed to predict a fully de-noised example from an additionally noised training example. This configuration enables the model to match the distribution at the clean sample, paving the way for one-step sampling.

Another technical effect and benefit is the introduction of an improved reconstruction loss term at the clean sample. This term explicitly matches the distribution at the clean sample, reducing the variance introduced by the additive Gaussian noise when sampling with the generator model.

Furthermore, some example implementations can make use of a pre-trained denoising diffusion model to initialize the generator and discriminator models. This strategy enables the model to leverage rich internal features that contain information about the intricate interplay between textual and visual data, resulting in improved training dynamics and quick convergence. Faster convergence results in reduced usage of computing resources.

In conclusion, the present invention provides a technical solution to the technical problem of slow and computationally demanding T2I generation by introducing a novel one-step T2I generation model. This model can perform high-quality image generation in a single step, with improved efficiency and speed.

With reference now to the Figures, example embodiments of the present disclosure will be discussed in further detail.

### Example Diffusion Models

### Diffusion Models

Diffusion models are a family of generative models that progressively inject Gaussian noises into the data, and then generate samples from noise via a reverse denoising process. Diffusion models define a forward process that corrupts data data x₀˜q(x₀) in T steps with variance schedule βₜ:

$$q ( {x}_{t} \vert {x}_{t - 1} ) := 𝒩 ( {x}_{t} ; \sqrt{1 - {β}_{t}} {x}_{t - 1} , {β}_{t} I ) ,$$

The parameterized reversed diffusion process aims to gradually recover cleaner data from noisy observations:

$${p}_{θ} ( {x}_{t - 1} \vert {x}_{t} ) := 𝒩 ( {x}_{t - 1} ; {μ}_{θ} ( {x}_{t} , t ) , {σ}_{t}^{2} I ) .$$

The model p_{θ}(xₜ₋₁|xₜ) is typically parameterized as a Gaussian distribution, because when the denoising step size from t to t−1 is sufficiently small, the true denoising distribution q(xₜ₋₁|xₜ) is a Gaussian. To train the model, one can maximize the ELBO objective:

$$ℒ = - {\sum }_{t > 0} {𝔼}_{q ( {x}_{0} ) q ( {x}_{t} \vert {x}_{0} )} K L ( q ( {x}_{t - 1} \vert {x}_{t} , {x}_{0} ) ‖ {p}_{θ} ( {x}_{t - 1} \vert {x}_{t} ) ) , \qquad ( 1 )$$

where q(xₜ₋₁|xₜ, x₀) is Gaussian posterior distribution. In some works, diffusion models are extended to continuous time under a unified framework of stochastic differential equations, but this description focuses on discrete-time diffusion models for ease of explanation.

In practice, employing diffusion models to represent high-dimensional data, such as high-resolution images, can be computationally demanding and inefficient. An alternative strategy involves data compression using a pre-trained auto-encoder, followed by training diffusion models on the resulting latent space. Notably, recent developments in latent diffusion models (see, e.g., Rombach et al. (2022) and Vahdat et al. (2021)) have demonstrated promising capabilities in efficiently generating high-resolution images. Among these, the Stable Diffusion model (Rombach et al. (2022) and Podell et al. (2023)) has obtained notable success, particularly in text-to-image generation tasks. Some example implementations of the present disclosure leverage the architecture of Stable Diffusion as the foundation for the proposed text-to-image model.

### Diffusion-GAN Hybrids

The diffusion model architectures can be combined with GAN training approaches. One primary motivation is that, when the denoising step size is large, the true denoising distribution q(xₜ₋₁|xₜ) is no longer a Gaussian. Therefore, instead of minimizing KL divergence with a parameterized Gaussian distribution, p_{θ}(xₜ₋₁|xₜ) can be parameterized as a conditional GAN to minimize the adversarial divergence between model p_{θ}(xₜ₋₁|xₜ) and q(xₜ₋₁|xₜ):

$${min}_{θ} {𝔼}_{q ( {x}_{t} )} [ {D}_{a d v} ( q ( {x}_{t - 1} \vert {x}_{t} ) ‖ {p}_{θ} ( {x}_{t - 1}^{′} \vert {x}_{t} ) ) ] . \qquad ( 2 )$$

One possible objective for a denoising diffusion model in a GAN framework can be expressed as:

$${min}_{θ} {max}_{{D}_{ϕ}} {𝔼}_{q ( {x}_{t} )} [ {𝔼}_{q ( {x}_{t - 1} \vert {x}_{t} )} [ - log ( {D}_{ϕ} ( {x}_{t - 1} , {x}_{t} , t ) ) ] + {𝔼}_{{p}_{θ} ( {{x}^{′}}_{t - 1} \vert {x}_{t} )} [ - log ( 1 - {D}_{ϕ} ( {x}_{t - 1}^{′} , {x}_{t} , t ) ) ] ] , \qquad ( 3 )$$

where D_{ϕ} is the conditional discriminator network, and the expectation over the unknown distribution q(xₜ₋₁|xₜ) can be approximated by sampling from q(x₀)q(xₜ₋₁|x₀)q(xₜ|xₜ₋₁). The flexibility of a GAN-based denoising distribution surpasses that of a Gaussian parameterization, enabling more aggressive denoising step sizes. Consequently, training using objective (3) successfully achieves a reduction in the required sampling steps to just four.

Nonetheless, the utilization of a purely adversarial objective such as objective (3) introduces training instability, which results in an inability to perform effectively on larger datasets like ImageNet. In response to this challenge, another possible approach matches the joint distribution q(xₜ₋₁,xₜ) and p_{θ}(xₜ₋₁,xₜ), as opposed to the conditional distribution as outlined in Equation 2. This joint distribution matching approach can be disassembled into two components: the minimization of marginal distributions using adversarial divergence and the minimization of conditional distributions using KL divergence:

$${min}_{θ} {𝔼}_{q ( {x}_{t} )} [ {D}_{a d v} ( q ( {x}_{t - 1} ) ‖ {p}_{θ} ( {x}_{t - 1} ) ) + {λ}_{K L} K L ( {p}_{θ} ( {x}_{t} \vert {x}_{t - 1} ) ‖ q ( {x}_{t} \vert {x}_{t - 1} ) ) ] . \qquad ( 4 )$$

The objective of adversarial divergence minimization in Equation 4 is similar to Equation 3 except that the discriminator does not take xₜ as part of its input. The KL divergence minimization translates into a straightforward reconstruction objective, facilitated by the Gaussian nature of the diffusion process. This introduction of a reconstruction objective plays an important role in enhancing the stability of the training dynamics, leading to markedly improved results, especially on more intricate datasets.

### Example Diffusion-GAN Improvements

This section presents a comprehensive overview of proposed enhancements to diffusion-GAN hybrid models, ultimately giving rise to the UFOGen model. These improvements are primarily focused on two domains: First, enabling one step sampling. Second, scaling-up for text-to-image generation.

### Enabling One-Step Sampling for UFOGen

Diffusion-GAN hybrid models are tailored for training with a large denoising step size. However, attempting to train these models with just a single denoising step (i.e., x_{T-1}=x₀) effectively reduces the training to that of a conventional GAN. Consequently, prior diffusion-GAN models were unable to achieve one-step sampling. In light of this challenge, the present disclosure provides specific modifications in the generator parameterization and the reconstruction term within the objective. These adaptations enable the proposed models to perform one-step sampling, while retaining training with several denoising steps.

### Parameterization of the Generator

In diffusion-GAN models, the generator should produce a sample of xₜ₋₁. However, instead of directly outputting xₜ₋₁, certain alternative approaches parameterize the generator by p_{θ}(xₜ₋₁|xₜ)=q(xₜ₋₁|xₜ, x₀=G_{θ}(xₜ, t)). In other words, first x₀ is predicted using the denoising generator G_{θ}(xₜ, t), and then, xₜ₋₁ is sampled using the Gaussian posterior distribution q(xₜ₋₁|xₜ,x₀). Note that this parameterization is mainly for practical purposes and alternative parameterization would not break the model formulation.

This section proposes another plausible parameterization for the generator: p_{θ}(xₜ₋₁|xₜ)=q(xₜ₋₁|xₜ,x₀=G_{θ}(xₜ,t)). The generator still predicts x₀, but xₜ₋₁ is sampled from the forward diffusion process q(xₜ₋₁|xₜ) instead of the posterior. This design allows distribution matching at x₀, paving the path to one-step sampling.

### Improved Reconstruction Loss at x₀

With the new generator parameterization given above, the objective in Equation 4 indirectly matches the distribution at x₀. To see this, analyze the adversarial objective and KL objective in Equation 4 separately. The first term minimizes adversarial divergence D_{adv}(q(xₜ₋₁)∥p_{θ}(x′ₜ₋₁)), where q(xₜ₋₁) and p_{θ}(x′ₜ₋₁) can both be seen as the corruption of a distribution at x₀ by the same Gaussian kernel. Specifically, since q(xₜ₋₁)= [symbol] _{q(x}_{₀}₎[q(xₜ₋₁|x₀)], given a sample of clean data x₀˜q(x₀), we have q(xₜ)= [symbol] (xₜ₋₁;\sqrt{α̅ₜ₋₁}x₀, (1−α̅ₜ₋₁)I), according to the forward diffusion. Similarly, p_{θ}(x′ₜ₋₁) has the same form except that x₀ is produced by the generator. As a result, adversarial distribution matching on q(xₜ₋₁) and p_{θ}(x′ₜ₋₁) will also encourage the matching between q(x₀) and p_{θ}(x′₀), which is the distribution over x₀ produced by the generator.

The second term in the objective minimizes the KL divergence between p_{θ}(xₜ|xₜ₋₁′)∥(xₜ|xₜ₋₁), which can be simplified to the following reconstruction term:

$${𝔼}_{q ( {x}_{t} )} ⌈ \frac{( 1 - {β}_{t} ) {‖ {x}_{t - 1}^{′} - {x}_{t - 1} ‖}^{2}}{2 {β}_{t}} ⌉ . \qquad ( 5 )$$

Based on above analysis on x′ₜ₋₁ and xₜ₋₁, it is easy to see that minimizing this reconstruction loss will essentially matches x₀ and x₀′ as well.

Per this analysis, with the generator parameterization introduced above, both terms in the objective in Equation 4 implicitly matches the distribution at x₀, which suggests that one-step sampling is possible if the model is well trained. However, empirically it was observed that one-step sampling without incorporating the proposed improvements does not work well on certain datasets. This may be is due to the variance introduced in the additive Gaussian noise when sampling xₜ₋₁ with x₀. To reduce the variance, some example implementations replace the reconstruction term in Equation 5 with the reconstruction at clean sample ∥x₀−x′₀∥², so that the matching at x₀ becomes explicit. With this change, the model can generate samples in one step.

### Training and Sampling

To put things together, this section presents the complete training objective and strategy for example implementations of the UFOGen model. In particular, example implementations of UFOGen can be trained with the following objective:

$${min}_{θ} {max}_{{D}_{ϕ}} {𝔼}_{q ( {x}_{0} ) q ( {x}_{t - 1} \vert {x}_{0} ) {,}_{{p}_{θ}} {( {x}_{0}^{′} )}_{{p}_{θ}} ( {x}_{t - 1}^{′} \vert {x}_{0}^{′} )} [ log ( {D}_{ϕ} ( {x}_{t - 1} , t ) ) ] + [ log ( 1 - {D}_{ϕ} ( {x}_{t - 1}^{′} , t ) ) ) ] + {λ}_{K L} {γ}_{t} {‖ {x}_{0} - {x}_{0}^{′} ‖}^{2} ] , \qquad ( 6 )$$

where γₜ is a time-dependent coefficient. The objective consists of an adversarial loss to match noisy samples at time step t−1, and a reconstruction loss at time step 0. An example formal training strategy of UFOGen is presented in Algorithm 1.

### Example Visualization of Training Objectives

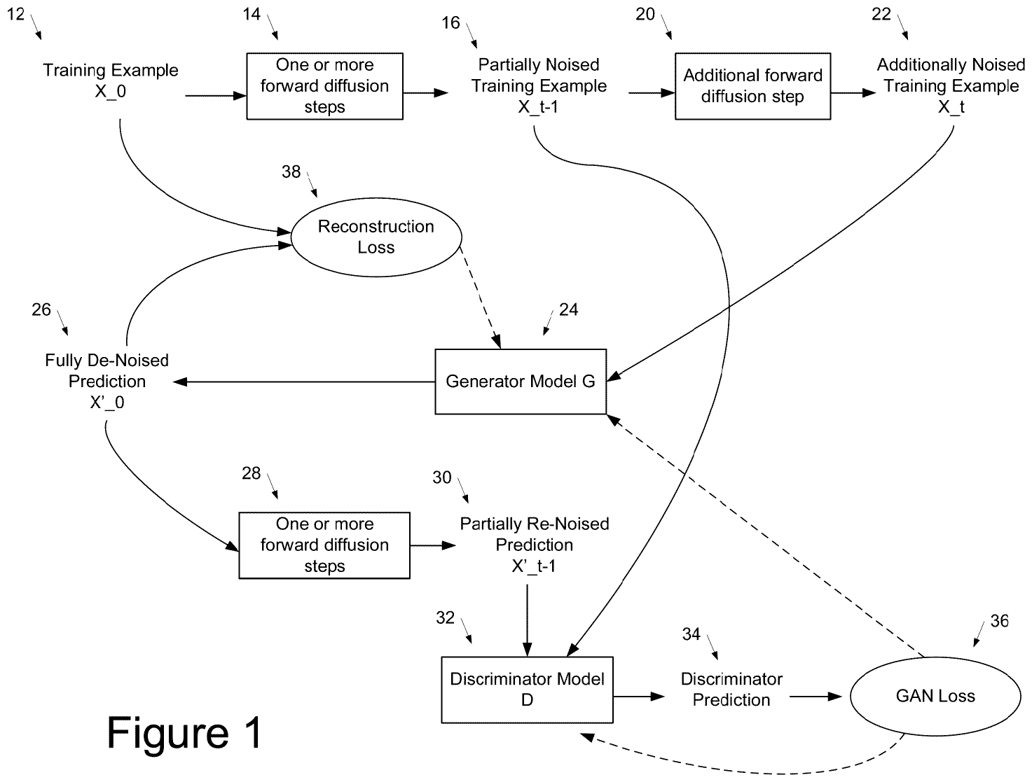

FIG. 1 depicts a graphical diagram of an example application of the improved training objectives described herein. FIG. 1 depicts a flow of operations in a training iteration, which includes obtaining a training example, performing several forward diffusion steps, processing the training example via generator and discriminator models, and updating the model parameters based on a unique loss function.

A first operation is the obtaining of a training example (12), which can be an image or a set of images. This example is used as the initial input for the training process.

Following this, one or more forward diffusion steps (14) are performed on the training example to generate a partially noised training example (16). This diffusion process involves corrupting the original data with added Gaussian noise, which is a fundamental operation in diffusion models.

To further increase the noise level, an additional forward diffusion step (20) is performed on the partially noised training example (16), resulting in an additionally noised training example (22). This operation continues the corruption of the original data, adding further complexity to the image.

The additionally noised training example (22) is then processed by a generator model (24) to generate a fully de-noised prediction (26). In some implementations, the generator model (24) can be instantiated from a pre-trained diffusion model and is capable of taking a noised image and denoising it in a single step.

Following the generation of the fully de-noised prediction (26), one or more forward diffusion steps (28) are performed on the prediction (26) to generate a partially re-noised prediction (30).

The partially re-noised prediction (30) is then processed by a discriminator model (32) to generate a discriminator prediction (34). The discriminator model (32) serves to classify whether the generated images from the generator model (24) are real or fake.

Lastly, one or more parameter values of the generator model (24) are updated based on a unique loss function. This loss function can include: a reconstruction loss term (38), which generates a reconstruction loss value based on the training example (12) and the fully de-noised prediction (26); and a GAN loss term (36), which generates a GAN loss value based on the discriminator prediction (34). This function serves to guide the generator (24) towards producing more realistic images.

In some implementations, the generator model (24) only performs a single denoising step to generate the fully de-noised prediction (26) from the additionally noised training example (22). This feature significantly accelerates the generative process and reduces computational requirements.

In some implementations, the generator model (24) performs a text-to-image generation task on the additionally noised training example (22) and a text prompt (not shown). This capability allows the generator to produce high-quality images from textual descriptions in a single step, marking a significant advancement in the field of text-to-image generation.

Furthermore, in some implementations, the reconstruction loss term (38) evaluates the KL divergence between the training example (12) and the fully de-noised prediction (26). This measure provides an indication of the similarity between the original data and the generated image, assisting in the optimization of the generator model.

In further implementations, the training process can also include updating the parameters of the discriminator model (32) based on a second GAN loss term that generates a second GAN loss value based on the discriminator prediction (34). This operation provides a balance between the generator and discriminator models, ensuring that both models learn and adapt concurrently.

Algorithm 1: UFOGen Training

Obtain : Generator G_{θ}, discriminator D_{ϕ}

| | |
|---|---|
| 1: | repeat |
| 2: | Sample x₀~q(x₀), t − 1~Uniform(0,..., T − 1). |
| 3: | Sample xₜ₋₁~q(xₜ₋₁\|x₀), xₜ~q(xₜ\|xₜ₋₁) |
| 4: | Sample x′ₜ₋₁~q(xₜ₋₁\|x_{0′}), where x′₀ = G_{θ}(xₜ, t) |
| 5: | Update D_{ϕ} with gradient ∇_{ϕ}(−log(D_{ϕ}(xₜ₋₁, t − 1)) − log(1 − |
| | D_{ϕ}(x′ₜ₋₁, t − 1)) |
| 6: | Update G_{θ} with gradient ∇_{θ}(−log(D_{ϕ}(x′ₜ₋₁, t − 1)) + λ_{KL}γₜ\|\|x₀ − |
| | x′₀\|\|₂² |
| 7: | until converged |

### Leverage Pre-Trained Diffusion Models for Text-to-Image Generation

One objective of the present disclosure is developing an ultra-fast, large-scale generative model for text-to-image generation. However, the transition from the improved training objects described above to web-scale data applications presents considerable challenges.

Training diffusion-GAN hybrid models for text-to-image generation encounters several intricacies. Notably, the discriminator must make judgments based on both texture and semantics, which govern text-image alignment. This challenge is particularly pronounced during the initial stage of training, when the generator has not yet acquired the capacity to generate coherent images.

Moreover, the cost of training text-to-image models can be extremely high, particularly in the case of GAN-based models, where the discriminator introduces additional parameters. Purely GAN-based text-to-image models confront similar complexities, resulting in highly intricate and expensive training.

To surmount the challenges associated with the scale-up of diffusion-GAN hybrid models, example aspects of the present disclosure are directed to the utilization of pre-trained text-to-image diffusion models, such as, for example, the Stable Diffusion model. Specifically, example models described herein can employ a consistent U-Net structure for both its generator and discriminator. This design enables seamless initialization with the pre-trained diffusion model (e.g., pre-trained latent diffusion model). The internal features within the pre-trained model contain rich information of the intricate interplay between textual and visual data. This initialization strategy significantly streamlines the training of UFOGen. Upon initializing UFOGen's generator and discriminator with the latent diffusion model, stable training dynamics and remarkably fast convergence.

### Example Visualization of Leveraging Pre-Trained Diffusion Models

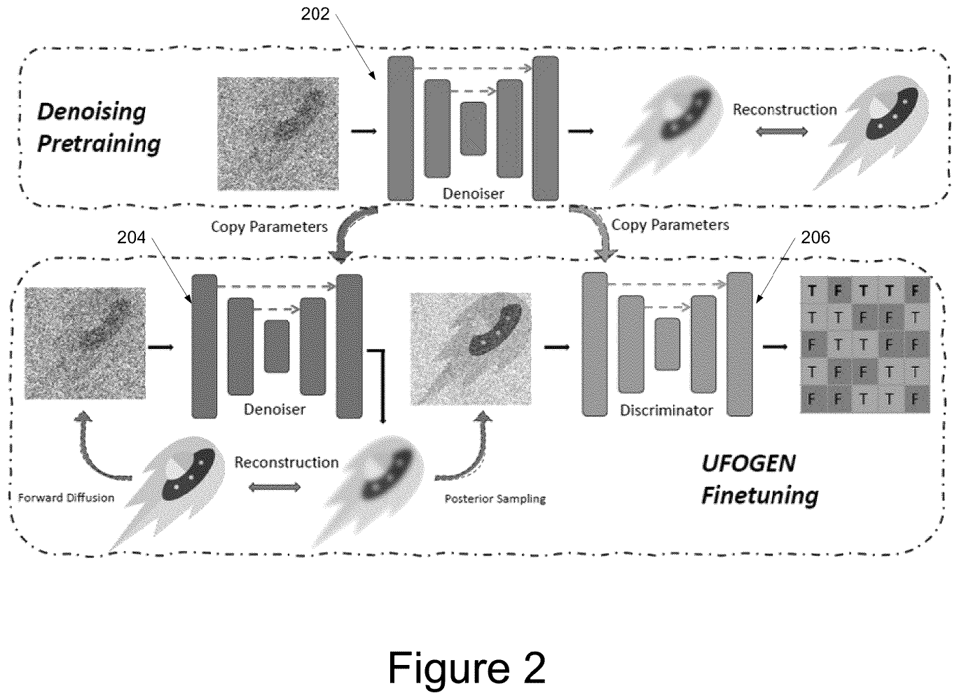

FIG. 2 illustrates an example system and process for training a one-step text-to-image generative model in accordance with the present disclosure. FIG. 2 provides a depiction of the initialization, instantiation, and finetuning of models using a pre-trained denoising diffusion model, which forms the foundation of the proposed one-step text-to-image generative model.

At the beginning of the process, a computing system obtains a pre-trained denoising diffusion model (202). This model can include a set of pre-trained model parameters that have been trained on a large-scale dataset. The denoising diffusion model can be of any design that has demonstrated proficiency in generative modeling tasks. In some embodiments, this pre-trained model may be a pre-trained latent diffusion model.

Following the acquisition of the pre-trained denoising diffusion model (202), the computing system proceeds to instantiate two instances of this model. The first instance of the pre-trained denoising diffusion model serves as a generator model, as shown at (204). This model is responsible for generating synthetic data, such as images, based on input data, such as textual descriptions. The generator model is initialized with the set of pre-trained model parameters obtained from the pre-trained denoising diffusion model.

Similarly, the second instance of the pre-trained denoising diffusion model is instantiated as a discriminator model, as depicted at (206). This model receives the synthetic data produced by the generator model and provides feedback that guides the further training of the generator model. Like the generator model, the discriminator model is also initialized with the set of pre-trained model parameters from the pre-trained denoising diffusion model.

Once the generator and discriminator models are instantiated, the computing system proceeds to finetune the generator model on a finetuning dataset, as indicated in block (208). The finetuning process involves modifying the set of pre-trained model parameters of the generator model. The modifications to the parameters are guided by a Generative Adversarial Network (GAN) loss term, which provides a loss value based on the output of the discriminator model. The GAN loss term essentially measures the difference between the synthetic data generated by the generator model and real data from the finetuning dataset, driving the generator model to produce more realistic images. As one example, the generator (202) can be trained via application of the training objectives shown in and described with reference to FIG. 1.

In addition to the GAN loss term, the finetuning process of the generator model can incorporate a reconstruction loss term. This term provides a loss value based on the output of the generator model itself, helping to match the distribution at the clean sample.

In some implementations of the present disclosure, the finetuning of the generator model can be directed towards a text-to-image generation task. This enables the model to generate high-quality images conditioned on textual descriptions in a single inference step. Furthermore, the finetuning process can also be directed towards domain-specific downstream tasks. This versatility extends the applicability of the model beyond general text-to-image generation, making it suitable for a wide range of generative scenarios.

In some implementations, after finetuning, the generator model in the illustrated framework is able to process a noise sample and generate a denoised synthetic image in a single denoising step. This feature is enabled by the novel modifications made to the training objective, allowing the model to perform one-step sampling while training with several denoising steps.

Algorithm 2: One-Step Sampling

| | |
|---|---|
| 1: | x_{T}~ [symbol] (0, I) |
| 2: | x₀ = G_{θ}(x_{T}, T) |
| 3: | return x₀ |

### Example Devices and Systems

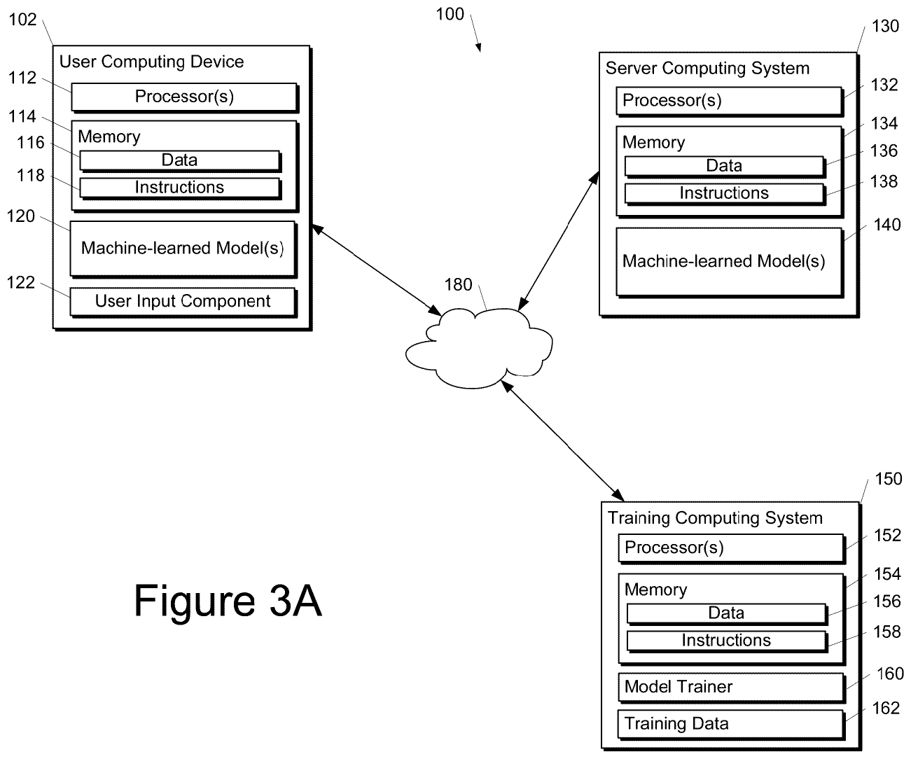

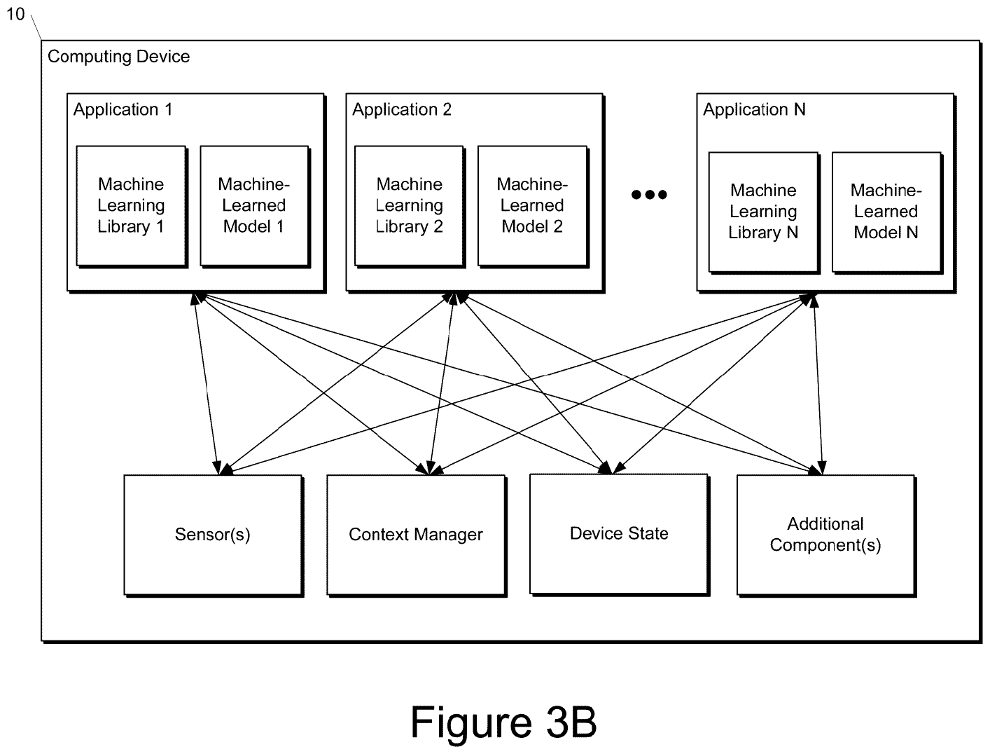

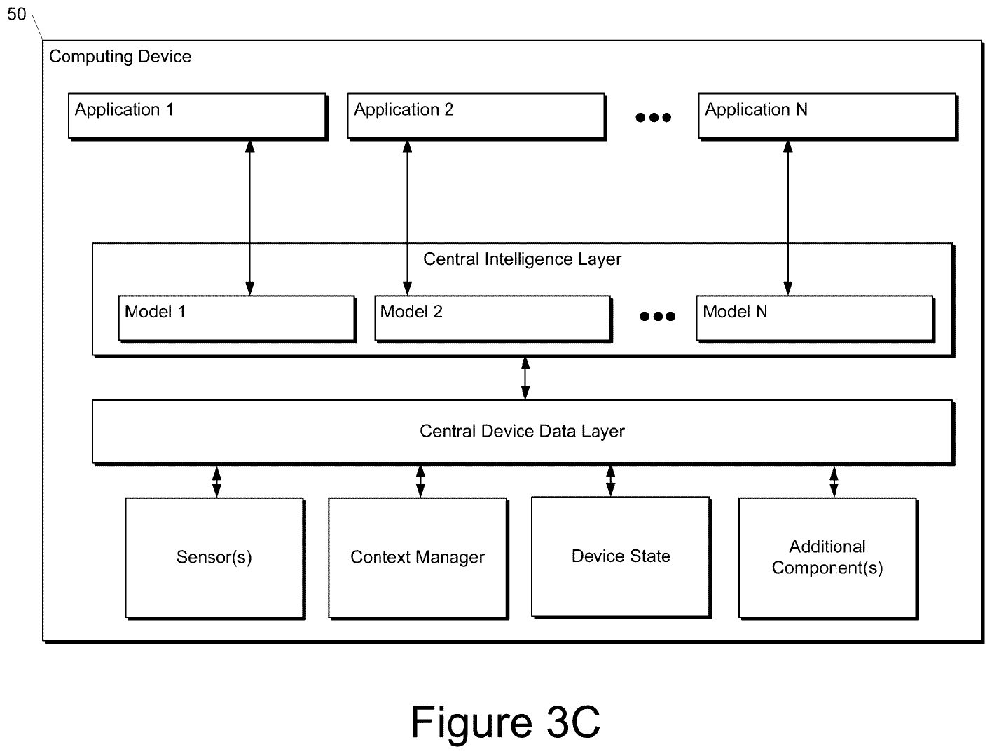

FIG. 3A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1 and 2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image generation across multiple instances of text inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an image generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1 and 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, images such as real images.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to train machine learning models, the method comprising:
obtaining, by a computing system comprising one more computing devices, a pre-trained denoising diffusion model comprising a set of pre-trained model parameters;
instantiating, by the computing system, a first instance of the pre-trained denoising diffusion model as a generator model having the set of pre-trained model parameters;
instantiating, by the computing system, a second instance of the pre-trained denoising diffusion model as a discriminator model having the set of pre-trained model parameters; and
finetuning, by the computing system, at least the generator model on a finetuning dataset, wherein finetuning, by the computing system, the generator model comprises modifying, by the computing system, the set of pre-trained model parameters of the generator model based on a generative adversarial network loss term that provides a loss value based on an output of the discriminator model.

2. The computer-implemented method of claim 1, wherein finetuning, by the computing system, the generator model further comprises modifying, by the computing system, the set of pre-trained model parameters of the generator model based on a reconstruction loss term that provides a loss value based on an output of the generator model.

3. The computer-implemented method of claim 1, wherein finetuning, by the computing system, the generator model further comprises finetuning, by the computing system, the generator model on a text-to-image generation task.

4. The computer-implemented method of claim 1, wherein finetuning, by the computing system, the generator model further comprises finetuning, by the computing system, the generator model on a domain-specific downstream task.

5. The computer-implemented method of claim 1, wherein the generator model is configured to receive and process a noise sample to generate a denoised synthetic image in a single denoising step.

6. The computer-implemented method of claim 1, wherein the pre-trained denoising diffusion model comprises a pre-trained latent diffusion model.

7. The computer-implemented method of claim 1, wherein the pre-trained denoising diffusion model comprises a U-Net.

8. A computer system comprising one or more computing devices, the computing system configured to perform operations to train image generation models, the operations comprising:
obtaining a training example comprising a training image;
performing one or more forward diffusion steps on the training example to generate a partially noised training example;
performing an additional forward diffusion step on the partially noised training example to generate an additionally noised training example;
processing the additionally noised training example with a generator model to generate fully de-noised prediction, wherein the generator model comprises a denoising diffusion model;
performing one or more forward diffusion steps on the fully de-noised prediction to generate a partially re-noised prediction;
processing the partially re-noised prediction with a discriminator model to generate a discriminator prediction; and
updating one or more parameter values of at least the generator model based on a loss function, wherein the loss function comprises: a reconstruction loss term that generates a reconstruction loss value based on the training example and the fully de-noised prediction, and a GAN loss term that generates a GAN loss value based on the discriminator prediction.

9. The computer system of claim 8, wherein processing the additionally noised training example with the generator model to generate fully de-noised prediction comprises performing only a single denoising step with the generator model to generate fully de-noised prediction from the additionally noised training example.

10. The computer system of claim 8, wherein processing the additionally noised training example with the generator model to generate fully de-noised prediction comprises performing a text-to-image generation task on the additionally noised training example and a text prompt.

11. The computer system of claim 8, wherein the generator model and the discriminator model have both been initialized from a pre-trained diffusion model.

12. The computer system of claim 8, wherein the generator model and the discriminator model have both been initialized from a pre-trained diffusion model.

13. The computer system of claim 8, wherein the generator model and the discriminator model have both been initialized from a pre-trained latent diffusion model.

14. The computer system of claim 8, wherein the generator model and the discriminator model both comprise a U-Net architecture.

15. The computer system of claim 8, wherein the reconstruction loss term evaluates a KL divergence between the training example and the fully de-noised prediction.

16. The computer system of claim 8, wherein the operations further comprise updating one or more parameter values of the discriminator model based on a second GAN loss term that generates a second GAN loss value based on the discriminator prediction.

17. One or more non-transitory computer-readable media that store a generator model that has been trained by performance of training operations, the training operations comprising:
obtaining, by a computing system comprising one more computing devices, a pre-trained denoising diffusion model comprising a set of pre-trained model parameters;
instantiating, by the computing system, a first instance of the pre-trained denoising diffusion model as the generator model having the set of pre-trained model parameters;
instantiating, by the computing system, a second instance of the pre-trained denoising diffusion model as a discriminator model having the set of pre-trained model parameters; and
finetuning, by the computing system, at least the generator model on a finetuning dataset, wherein finetuning, by the computing system, the generator model comprises modifying, by the computing system, the set of pre-trained model parameters of the generator model based on a generative adversarial network loss term that provides a loss value based on an output of the discriminator model.

18. The one or more non-transitory computer-readable media of claim 17, wherein finetuning, by the computing system, the generator model further comprises modifying, by the computing system, the set of pre-trained model parameters of the generator model based on a reconstruction loss term that provides a loss value based on an output of the generator model.

19. The one or more non-transitory computer-readable media of claim 17, wherein finetuning, by the computing system, the generator model further comprises finetuning, by the computing system, the generator model on a text-to-image generation task.

20. The one or more non-transitory computer-readable media of claim 17, wherein finetuning, by the computing system, the generator model further comprises finetuning, by the computing system, the generator model on a domain-specific downstream task.
